(19) United States
(12) Patent Application Publication
(10) Pub. No.: US 2019/0258255 A1
(43) Pub. Date: Aug. 22, 2019

(54) CONTROL DEVICE, IMAGING SYSTEM, MOVABLE OBJECT, CONTROL METHOD, AND PROGRAM

(71) Applicant: SZ DJI TECHNOLOGY CO., LTD., Shenzhen (CN)

(72) Inventor: Yoshinori NAGAYAMA, Tokyo (JP)

(21) Appl. No.: 16/401,195

(22) Filed: May 2, 2019

Related U.S. Application Data
(63) Continuation of application No. PCT/JP2016/084351, filed on Nov. 18, 2016.

(51) Int. Cl. G05D 1/00; B64C 39/02; H04N 5/232; H04N 5/262; G05D 1/10

(52) U.S. Cl. CPC G05D 1/0094; B64C 39/024; H04N 5/23296; B64C 2201/123; G05D 1/1062; B64C 2201/127; H04N 5/2628

(57) ABSTRACT

A control device includes a control circuitry configured to estimate a first position for a movable object to reach by a time point in association with movement of an object, derive a first speed that the movable object needs to reach the first position by the time point, and determine if the first speed is greater than a second speed, beyond which the movable object is not able to track the object. If so, the control circuitry determines a second position that the movable object is able to reach by the time point by moving toward the first position at the second speed, and defines at least one of an imaging condition or an imaging direction of an imaging system carried by the movable object based on a relative position between the movable object at the second position and the object at the time point.

### CROSS-REFERENCE TO RELATED APPLICATION

This application is a continuation of International Application No. PCT/JP2016/084351, filed on Nov. 18, 2016, the entire content of which is incorporated herein by reference.

The scope of the claims, specification, drawings, and abstract include matters subject to protection by copyright. The owner of copyright does not raise objections to duplication by any person of these documents if it is as displayed in the files or records of the Patent Office. However, in all other cases, all copyrights are reserved.

### FIELD

The disclosed embodiments relate to a control device, an imaging system, a movable object, a control method, and a program.

### BACKGROUND

The specification of U.S. Patent Application Publication No. 2013/0162822 describes a method for an unmanned aerial vehicle provided with a camera to capture an image of a target.

Patent Literature 1 U.S. Patent Application Publication No. 2013/0162822 Specification

When an object is imaged by an imaging system mounted in a movable object that is tracking the object, the movable object may not be able to adequately track the object and the imaging system may be unable to adequately image the object.

A control device according to an aspect of the present disclosure can include an estimating unit for estimating a first position a movable object must reach at a first time point in association with movement of an object, the movable object tracking the object so as to maintain a predetermined distance from the object. The control device can include a derivation unit for deriving a first speed of the movable object needed for the movable object to reach the first position at the first time point. The control device can include a first determining unit for determining a second position that the movable object is able to reach at the first time point by moving toward the first position, when the first speed is greater than a second speed at which the movable object is able to move while tracking the object. The control device can include a defining unit for defining at least one of an imaging condition or an imaging direction of an imaging system provided to the movable object, the imaging condition and imaging direction being used for imaging the object with the imaging system at the first time point, the defining unit defining the at least one of the imaging condition or the imaging direction based on relative positions of the movable object, which is at the second position, and the object at the first time point.

The defining unit can define at least one of a focus condition or a zoom condition of the imaging system as the imaging condition, based on a distance between the movable object, which is at the second position, and the object at the first time point.

The defining unit can define the focus condition of the imaging system based on the distance between the movable object, which is at the second position, and the object at the first time point, and can define the zoom condition of the imaging system based on a difference between the predetermined distance and the distance between the movable object, which is at the second position, and the object at the first time point.

The control device can include a second determining unit for determining the second speed for when the movable object moves toward the first position.

The control device can include a first predicting unit for predicting a movement direction of the movable object while the movable object is moving toward the first position. The second determining unit can determine the second speed based on the movement direction of the movable object.

The control device can include a second predicting unit for predicting environmental conditions in the area of the movable object while the movable object is moving toward the first position. The second determining unit can determine the second speed based on the environmental conditions in the area of the movable object.

An imaging system according to another aspect of the present disclosure can include an imaging device, the imaging device including the control device described above and imaging the object based on the imaging condition. The imaging system can include a carrier for supporting the imaging device such that the imaging direction of the imaging device is adjustable.

A movable object according to another aspect of the present disclosure can include the imaging system.

A control method according to another aspect of the present disclosure can include estimating a first position a movable object must reach at a first time point in association with movement of an object, the movable object tracking the object so as to maintain a predetermined distance from the object. The control method can include deriving a first speed of the movable object needed for the movable object to reach the first position at the first time point. The control method can include determining a second position that the movable object is able to reach at the first time point by moving toward the first position, when the first speed is greater than a second speed at which the movable object is able to move while tracking the object. The control method can include defining at least one of an imaging condition or an imaging direction of an imaging system provided to the movable object, the imaging condition and imaging direction being used for imaging the object with the imaging system at the first time point, the control method defining the at least one of the imaging condition or the imaging direction based on relative positions of the movable object, which is at the second position, and the object at the first time point.

A program according to another aspect of the present disclosure can cause a computer to estimate a first position a movable object must reach at a first time point in association with movement of an object, the movable object tracking the object so as to maintain a predetermined distance from the object. The program can cause the computer to derive a first speed of the movable object needed for the movable object to reach the first position at the first time point. The program can cause the computer to determine a second position that the movable object is able to reach at the first time point by moving toward the first position, when the first speed is greater than a second speed at which the movable object is able to move while tracking the object. The program can cause the computer to define at least one of an imaging condition or an imaging direction of an imaging system provided to the movable object, the imaging condition and imaging direction being used for imaging the object with the imaging system at the first time point, the computer defining the at least one of the imaging condition or the imaging direction based on relative positions of the movable object, which is at the second position, and the object at the first time point.

When an object is imaged by an imaging system mounted in a movable object that is tracking the object, it is possible to prevent the movable object from being unable to adequately track the object and to prevent the imaging system from being unable to adequately image the object.

The features described above can also be arranged into a variety of sub-combinations.

### BRIEF DESCRIPTION OF THE DRAWINGS

FIG. 1 illustrates one example of an exterior of an unmanned aerial vehicle (UAV).

FIG. 2A illustrates one example of a change over time in the speeds of an object and the UAV.

FIG. 2B illustrates one example of a change over time in the distances of the object and the UAV from an operator.

FIG. 3 illustrates one example of a UAV function block.

FIG. 4 is a flowchart illustrating one example of a tracking procedure for the UAV.

FIG. 5 illustrates one example of the UAV tracking.

FIG. 6 illustrates another example of the UAV tracking.

FIG. 7 illustrates one example of a hardware configuration.

### DETAILED DESCRIPTION OF THE EMBODIMENTS

The present disclosure is described below using embodiments of the disclosure, but the embodiments below do not limit the disclosure according to the scope of the claims. Not all combinations of features described in the embodiments are necessary to achieve the disclosure.

The various embodiments of the present disclosure can be described referencing flowcharts and block diagrams. In such depictions, the blocks can illustrate (1) a step of a process that executes an operation, or (2) a “unit” of a device having a role in executing an operation. A specific step or “unit” can be implemented through a programmable circuitry and/or a processor. A dedicated circuitry can include a digital and/or analog hardware circuitry. An integrated circuitry (IC) and/or discrete circuitry can be included. A programmable circuitry can include a reconfigurable hardware circuitry. The reconfigurable hardware circuitry can include a memory element, such as a logical AND, logical OR, logical XOR, logical NAND, logical NOR, and other logical operations; a flip-flop; a register; a field programmable gate array (FPGA); and a programmable logic array (PLA).

A computer-readable medium can include any tangible device that can store instructions to be executed by a suitable device. As a result, a computer-readable medium having instructions stored thereon can include a manufactured good that includes instructions that can be executed to create means for executing operations designated in a flowchart or a block diagram. As for examples of computer-readable media, electronic recording media, magnetic recording media, optical recording media, electromagnetic recording media, semiconductor recording media, and the like can be included. As for more specific examples of computer-readable media, floppy discs®, diskettes, hard discs, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray (RTM) discs, memory sticks, integrated circuitry cards, and the like can be included.

Computer-readable instructions can include either source code or object code written in any combination of one or more programming languages. The source code or object code can include a conventional procedural programming language. The conventional procedural programming language can be: assembler instructions; instruction set architecture (ISA) instructions; machine instructions; machine-dependent instructions; microcode; firmware instructions; state setting data; an object-oriented programming language such as Smalltalk, JAVA®, C++, or the like; “C” programming language; or a similar programming language. The computer-readable instructions can be provided to a processor or programmable circuitry of a general-purpose computer, a special-purpose computer, or another programmable data processing device either locally or via a local area network (LAN) or a wide area network (WAN) such as the Internet. The processor or programmable circuitry can execute computer-readable instructions in order to create means for executing the operations designated in a flowchart or block diagram. Examples of a processor can include a computer processor, a processing unit, a microprocessor, a digital signal processor, a controller, a microcontroller, and the like.

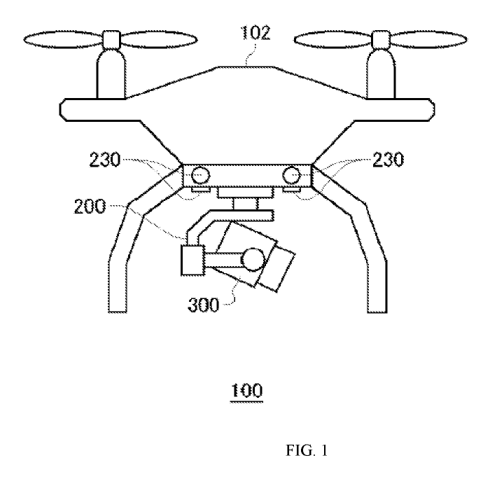

FIG. 1 illustrates one example of an exterior of an unmanned aerial vehicle (UAV) 100. The UAV 100 can include a UAV body 102, a gimbal 200, an imaging device 300, and a plurality of imaging devices 230. The UAV 100 is one example of a movable object. The movable object can be a concept that includes, in addition to UAVs, other aerial vehicles moving in the air, vehicles moving on the ground, ships moving in the water, and the like. The gimbal 200 and the imaging device 300 are one example of an imaging system.

The UAV body 102 can include a plurality of rotary wings. The UAV body 102 can cause the UAV 100 to fly by controlling the rotation of the plurality of rotary wings. For example, the UAV body 102 can cause the UAV 100 to fly by using four rotary wings. The number of rotary wings is not limited to four. Also, the UAV 100 can be a fixed-wing aircraft that does not have rotary wings.

The imaging device 300 can be a camera for imaging that images an object to be tracked. The plurality of imaging devices 230 can be cameras for sensing, which image the surroundings of the UAV 100 in order to control the flight of the UAV 100. Two imaging devices 230 can be provided on a front face, which is the nose of the UAV 100. Further, another two imaging devices 230 can be provided on a bottom face of the UAV 100. The two imaging devices 230 on the front face side can act as a pair and function as what is known as a stereo camera. The two imaging devices 230 on the bottom face side can also act as a pair and function as a stereo camera. A distance from the UAV 100 to the object can be measured based on the images imaged by the plurality of imaging devices 230. Three-dimensional spatial data of the surroundings of the UAV 100 can be generated based on the images imaged by the plurality of imaging devices 230. The number of imaging devices 230 provided on the UAV 100 is not limited to four. The UAV 100 can include at least one imaging device 230. The UAV 100 can include at least one imaging device 230 on each of the nose, tail, sides, bottom surface, and upper surface of the UAV 100. An angle of view that can be set on the imaging devices 230 can be wider than an angle of view that can be set on the imaging device 300. The imaging devices 230 can have a single focus lens or a fisheye lens.

With the UAV 100 configured in this way, a specified object can be imaged by the imaging devices 230 and the imaging device 300 while the UAV 100 tracks the object. The UAV 100 can perform tracking such that the UAV 100 maintains a predetermined distance from the object. When the object performs a predictable movement, the UAV 100 can easily image the object with the imaging device 300 while maintaining the predetermined distance from the object. However, when the object moves at a speed greater than a limit speed at which the UAV 100 is able to perform tracking while moving, for example, the UAV 100 cannot maintain the predetermined distance from the object. In such a case, the imaging device 300 may be unable to adequately image the object.

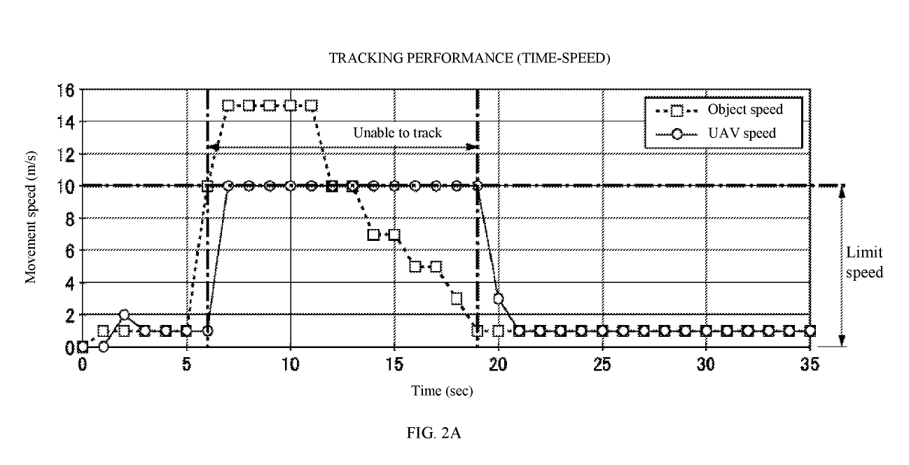

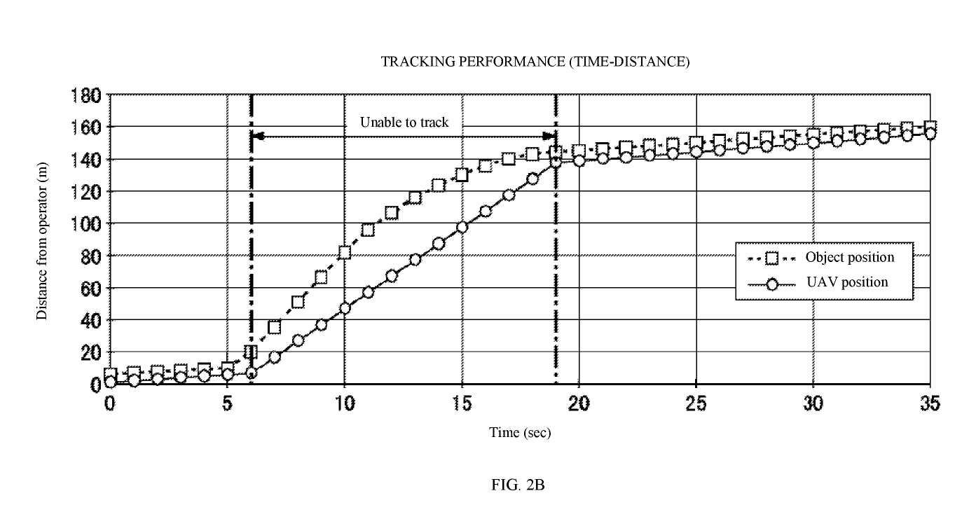

FIG. 2A illustrates one example of a change over time in the speeds of the object and the UAV 100. FIG. 2B illustrates one example of a change over time in the distance to the object from an operator operating the UAV 100, and the distance to the UAV 100 from the operator. As illustrated in FIGS. 2A and 2B, when the speed of the object is greater than the limit speed of the UAV 100, the UAV 100 cannot maintain the predetermined distance from the object, which may lead to a period of time where the UAV 100 cannot track the object.

During a period where tracking cannot be performed, the object is potentially not adequately imaged when an imaging condition and imaging direction of the imaging device 300 are set to the same conditions as in the tracking period. For example, when the imaging device 300 maintains a prescribed focus condition while imaging the object, the imaging device 300 may be unable to focus on the object and thus may be unable to adequately image the object. When the imaging element or lens provided to the imaging device 300 is increased in size, the depth of field narrows and therefore focusing on the object can become difficult.

Thus, there is a limit to the ability to continue favorable imaging of the object by simply adjusting the speed of the UAV 100. Given this, the UAV 100 according to the present embodiment can predict, in advance, a situation where the UAV 100 may become unable to maintain the predetermined distance from the object and, in light of the predicted situation, can define at least one of the imaging condition or the imaging direction in advance. This can prevent the imaging device 300 from being unable to adequately image the object during the period of time where the UAV 100 is unable to maintain the predetermined distance from the object.

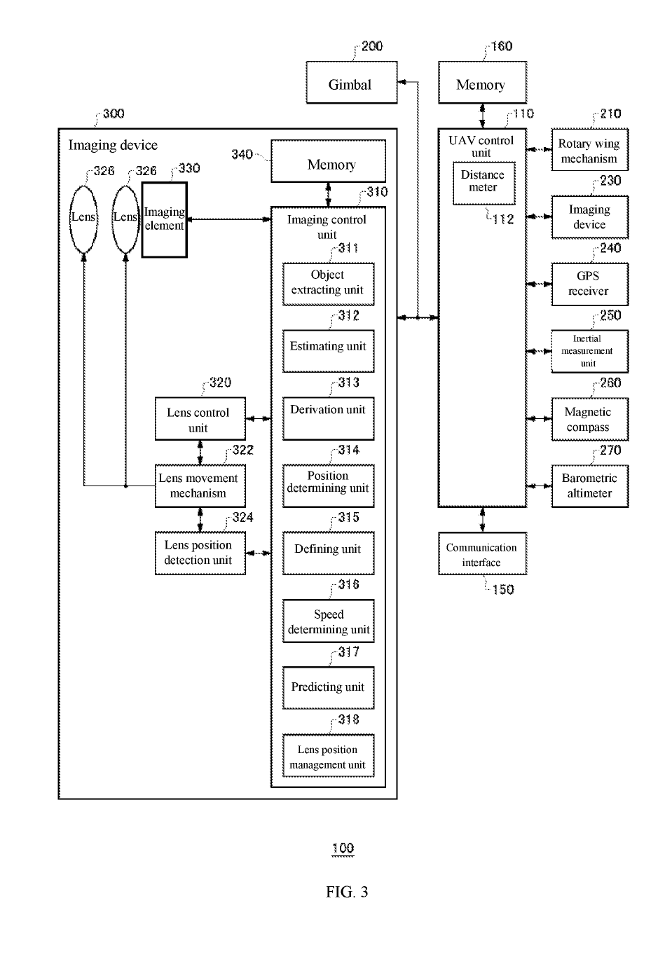

FIG. 3 illustrates one example of a function block of the UAV 100. The UAV 100 can include a UAV control unit 110, a communication interface 150, a memory 160, a gimbal 200, a rotary wing mechanism 210, the imaging device 300, the imaging devices 230, a GPS receiver 240, an inertial measurement unit (IMU) 250, a magnetic compass 260, and a barometric altimeter 270.

The communication interface 150 can communicate with an external transmitter. The communication interface 150 receives a variety of instructions for the UAV control unit 110 from a remote transmitter. The memory 160 stores programs and the like needed for the UAV control unit 110 to control the gimbal 200, the rotary wing mechanism 210, the imaging devices 300, the imaging device 230, the GPS receiver 240, the IMU 250, the magnetic compass 260, and the barometric altimeter 270. The memory 160 can be a computer-readable recording medium, and can include at least one from among SRAM, DRAM, EPROM, EEPROM, and flash memory such as USB memory. The memory 160 can be provided inside the UAV body 102. The memory 160 can be provided such that it is detachable from the UAV body 102.

The gimbal 200 can support the imaging device 300 such that the imaging direction of the imaging device 300 can be adjusted. The gimbal 200 can rotatably support the imaging device 300 to rotate centered on at least one axis. The gimbal 200 is one example of a carrier. The gimbal 200 can rotatably support the imaging device 300 to rotate centered on a yaw axis, a pitch axis, and a roll axis. The gimbal 200 can change the imaging direction of the imaging device 300 by rotating the imaging device 300 centered on at least one of the yaw axis, the pitch axis, or the roll axis. The rotary wing mechanism 210 can have a plurality of rotary wings and a plurality of drive motors for rotating the plurality of rotary wings.

The imaging devices 230 can image the surroundings of the UAV 100 and generate image data. The image data from the imaging devices 230 can be stored in the memory 160. The GPS receiver 240 can receive a plurality of signals indicating the time at which the signals were transmitted from a plurality of GPS satellites. The GPS receiver 240 can calculate the position of the GPS receiver 240 (that is, the position of the UAV 100) based on the plurality of signals received. The inertial measurement unit (IMU) 250 can detect the attitude of the UAV 100. The IMU 250 can detect acceleration of the UAV 100 in three axial directions (forward/backward, right/left, and up/down) and angular velocity in three axial directions (pitch, roll, and yaw) to represent the attitude of the UAV 100. The magnetic compass 260 can detect the bearing of the nose of the UAV 100. The barometric altimeter 270 can detect the altitude at which the UAV 100 is flying.

The UAV control unit 110 can control the flight of the UAV 100 by following a program stored in the memory 160. The UAV control unit 110 can be configured from a microprocessor such as a CPU or MPU, a microcontroller such as an MCU, or the like. The UAV control unit 110 can control the flight of the UAV 100 following instructions received from a remote transmitter via the communication interface 150.

The UAV control unit 110 can identify an environment around the UAV 100 by analyzing the plurality of images imaged by the plurality of imaging devices 230. The UAV control unit 110 can control the flight of the UAV 100 so as to avoid obstacles, for example, based on the environment around the UAV 100. The UAV control unit 110 can generate three-dimensional spatial data of the surroundings of the UAV 100 based on the plurality of images imaged by the plurality of imaging devices 230, and can control the flight of the UAV 100 based on the three-dimensional spatial data.

The UAV control unit 110 can include a distance meter 112. The distance meter 112 can measure the distance between the UAV 100 and the object with a triangulation method, based on the plurality of images imaged by the plurality of imaging devices 230. The distance meter 112 can also measure the distance between the UAV 100 and the object using an ultrasonic sensor, a radar sensor, or the like. The distance meter 112 can be provided to an imaging control unit 310.

The imaging device 300 can include the imaging control unit 310, a lens control unit 320, a lens movement mechanism 322, a lens position detection unit 324, a plurality of lenses 326, an imaging element 330, and a memory 340. The imaging control unit 310 can be configured from a microprocessor such as a CPU or MPU, a microcontroller such as an MCU, or the like. The imaging control unit 310 can control the imaging device 300 according to action instructions for the imaging device 300 provided from the UAV control unit 110. The imaging control unit 310 is one example of a control device. The memory 340 can be a computer-readable recording medium, and can include at least one from among SRAM, DRAM, EPROM, EEPROM, and flash memory such as USB memory. The memory 340 can be provided inside the housing of the imaging device 300. The memory 340 can be provided such that it is removable from the housing of the imaging device 300.

The imaging element 330 can be configured from CCD or CMOS. The imaging element 330 can be carried inside the housing of the imaging device 300, and can generate and output to the imaging control unit 310 image data of an optical image formed via the plurality of lenses 326. The imaging control unit 310 can perform a series of image processing operations such as noise reduction, demosaicing, gamma correction, edge enhancement, and the like on image data output from the imaging element 330, and can store the processed image data in the memory 340. The imaging control unit 310 can output image data to the memory 160 to be stored therein, via the UAV control unit 110. The imaging element 330 can be an imaging element employing a focal plane phase detection AF method, and can include a phase detection AF sensor. In such a case, the distance meter 112 can measure the distance between the UAV 100 and the object based on information from the phase detection AF sensor of the imaging element 330.

The lens control unit 320 can control the movement of the plurality of lenses 326 via the lens movement mechanism 322. All or a portion of the plurality of lenses 326 can be moved along an optical axis by the lens movement mechanism 322. Following lens action instructions from the imaging control unit 310, the lens control unit 320 can move at least one of the plurality of lenses 326 along the optical axis. The lens movement mechanism 320 can move at least one of the plurality of lenses 326 along the optical axis, and can thereby carry out at least one of a zoom action or a focus action. The lens position detection unit 324 can detect the current positions of the plurality of lenses 326. The lens position detection unit 324 can detect the current zoom position and focus position.

The imaging control unit 310 can include an object extracting unit 311, an estimating unit 312, a derivation unit 313, a position determining unit 314, a defining unit 315, a speed determining unit 316, a predicting unit 317, and a lens position management unit 318. A device other than the imaging device 300, such as the gimbal 200 or the UAV control unit 110, can include all or some of the object extracting unit 311, the estimating unit 312, the derivation unit 313, the position determining unit 314, the defining unit 315, the speed determining unit 316, the predicting unit 317, and the lens position management unit 318.

The object extracting unit 311 can extract a specified object from an image obtained from the imaging element 330. The object extracting unit 311 can define the specified object by causing a user to select a region in the image that includes the object. The object extracting unit 311 can infer the color, brightness, or contrast of the region selected by the user that includes the object. The object extracting unit 311 can divide the image into a plurality of regions. Based on the color, brightness, or contrast of each of the divided regions, the object extracting unit 311 can extract the specified object designated by the user. The object extracting unit 311 can extract, as the object, a subject in the center of an image region. The object extracting unit 311 can also extract, as the object, a subject that is closest to the UAV 100 out of the subjects present in the image region.

The object extracting unit 311 can continue extracting the current specified object from the image until the user selects a new object, or until losing sight of the object. Once the object extracting unit 311 loses sight of the specified object, if a region that includes a color, brightness, or contrast corresponding to the specified object can be extracted from a subsequent image within a predetermined period of time, the object extracting unit 311 can extract that region as the region that includes the specified object.

The estimating unit 312 can estimate a target position which the UAV 100 must reach, in association with the movement of the object, at a first time point in the future. The target position is an example of a first position. The estimating unit 312 can extract the object from the image in each frame. In each frame, the estimating unit 312 can acquire distance information indicating a distance from the UAV control unit 110 to the object, and can acquire position information indicating the position of the UAV 100. The position information can include information for latitude, longitude, and altitude. The estimating unit 312 can predict the speed and movement direction of the object based on the distance information and position information the estimating unit 312 is able to obtain up through the current frame. The estimating unit 312 can also predict the speed and movement direction of the object based on the distance information and the position information for the previous frame and the current frame. The estimating unit 312 can predict the position of the object in the next frame based on the predicted speed and movement direction of the object, and based on the position of the object in the current frame. Next, the estimating unit 312 can estimate the target position which the UAV 100 must reach in the next frame (first future time point) based on the position of the object in the next frame, the position of the UAV 100 in the current frame, and the predetermined distance established as a tracking condition.

The derivation unit 313 can derive a required speed for the UAV 100 that is needed for the UAV 100 to reach the target position at the first future time point. The required speed is one example of a first speed. The derivation unit 313 can also derive the required speed for the UAV 100 that is needed for the UAV 100 to reach the target position in the next frame based on the position of the UAV 100 in the current frame, and based on the target position estimated by the estimating unit 312.

When the required speed is greater than the limit speed at which the UAV 100 is able to move while tracking the object, the position determining unit 314 can determine an attained position that the UAV 100 is able to reach at the first time point by moving toward the target position. The attained position is an example of a second position. The position determining unit 314 is one example of a first determining unit. The position determining unit 314 can also determine the attained position that the UAV 100 is able to reach at the time point of the next frame by moving toward the target position at the limit speed. The position determining unit 314 can also determine the attained position that the UAV 100 is able to reach at the time point of the next frame by moving toward the target position at a predetermined speed below the limit speed. The limit speed is one example of a second speed.

The speed determining unit 316 can determine the limit speed for a case where the UAV 100 moves toward the target position. The limit speed can be a predefined speed that is defined according to the flight capabilities of the UAV 100. The limit speed can also be defined according to the flight direction of the UAV 100. Different limit speeds can be defined for when the UAV 100 is moving in a horizontal direction, when the UAV 100 is moving in an ascending direction or descending direction (vertical direction), and when the UAV 100 is moving horizontally while ascending or descending. The limit speed can be defined according to an environmental condition in the area of a flight path of the UAV 100. The limit speed can be defined according to wind speed and wind direction on the flight path of the UAV 100.

The predicting unit 317 can predict the movement direction of the UAV 100 while the UAV 100 is moving toward the target position. The predicting unit 317 can predict the movement direction of the UAV 100 based on the position of the UAV 100 in the current frame, and based on the target position. The predicting unit 317 can predict the environmental conditions in the area of the UAV 100 while the UAV 100 is moving toward the target position. For example, the predicting unit 317 can predict the environmental conditions in the area of the UAV 100 using weather information for the period that the UAV 100 is moving toward the target position. As another example, the predicting unit 317 can predict the wind speed and wind direction on the flight path of the UAV 100 using the weather information. The predicting unit 317 is one example of a first predicting unit and a second predicting unit.

The speed determining unit 316 can determine the limit speed based on the movement direction of the UAV 100. The speed determining unit 316 can also determine the limit speed based on the environmental conditions in the area of the UAV 100. The speed determining unit 316 can also determine the limit speed based on the wind speed and wind direction on the flight path of the UAV 100. The speed determining unit 316 can also determine the limit speed based on the movement direction of the UAV 100 as well as on the wind speed and wind direction on the flight path of the UAV 100.

Based on the relative positions of the UAV 100 (at the attained position) and the object at the first time point, the defining unit 315 can define at least one of the imaging condition or the imaging direction for imaging the object with the imaging device 300 at the first time point. Based on the relative positions of the UAV 100 (at the attained position) and the object at the first time point, the defining unit 315 can define a rotation amount of the imaging device 300 with the rotation centered on at least one of the yaw axis (pan axis) or the pitch axis (tilt axis). Based on the relative positions of the UAV 100 (at the attained position) and the object at the time point of the next frame, the defining unit 315 can define at least one of the imaging condition or the imaging direction for imaging the object with the imaging device 300 at the time point of the next frame. Based on the distance between the UAV 100 (at the attained position) and the object at the first time point, the defining unit 315 can define at least one of the focus condition and the zoom condition as the imaging condition. The defining unit 315 can define at least one of a movement amount of the zoom lens from the current zoom position or a movement amount of the focus lens from the current focus position as the imaging condition. Based on the distance between the UAV 100 (at the attained position) and the object at the first time point, the defining unit 315 can define the focus condition of the imaging device 300. Based on the distance between the UAV 100 (at the attained position) and the object at the time point of the next frame, the defining unit 315 can define the focus condition of the imaging device 300 for the next frame. Based on a difference between the predetermined distance and the distance between the UAV 100 (at the attained position) and the object at the time point of the next frame, the defining unit 315 can define the zoom condition of the imaging device 300 for the next frame. The defining unit 315 can define the focus condition using a degree of lens sensitivity (m/pulse) that is predefined by a design value for the focus lens. The defining unit 315 can derive a difference (m) between the predetermined distance and the distance between the UAV 100 (at the attained position) and the object at the time point of the next frame. Using the formula [difference (m)/lens sensitivity (m/pulse)], the defining unit 315 can define the movement amount (pulse) of the focus lens as the focus condition.

The lens position management unit 318 can manage the position information of the plurality of lenses 326, which is supplied from the lens position detection unit 324. The lens position management unit 318 can record in the memory 340 the current zoom position and the current focus position supplied from the lens position detection unit 324. The defining unit 315 can define the movement amount of the zoom lens and the focus lens before the next frame based on the current zoom position and the current focus position, which are under the management of the lens position management unit 318.

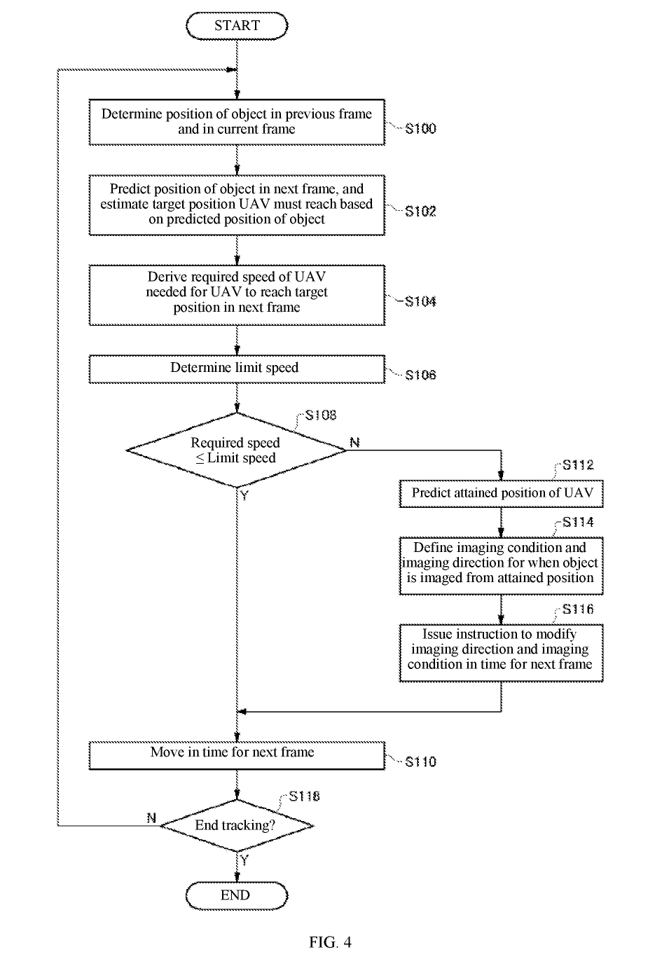

FIG. 4 is a flowchart illustrating one example of a tracking procedure for the UAV 100. The object extracting unit 311 can extract the object from the previous frame image and from the current frame image. The estimating unit 312 can determine the positions (latitude, longitude, and altitude) of the object in the previous frame and in the current frame based on the position of the object within the images, the distance to the object supplied from the UAV control unit 110, and the position information (latitude, longitude, and altitude) of the UAV 100 supplied from the UAV control unit 110 (S100). The estimating unit 312 can predict the position of the object in the next frame based on the positions of the object in the previous frame and the current frame. The estimating unit 312 can estimate the target position which the UAV 100 must reach in the next frame based on the predicted position of the object, the position of the UAV 100 in the current frame, and the predetermined distance to the object established for tracking (S102).

The derivation unit 313 can derive the required speed for the UAV 100 that is needed for the UAV 100 to reach the target position in the next frame based on the position of the UAV 100 in the current frame, and based on the target position (S104). The speed determining unit 316 can determine the limit speed at which the UAV 100 is able to move while tracking (S106). The speed determining unit 316 can also determine the limit speed based on the movement direction of the UAV 100 as well as on the wind speed and wind direction on the flight path of the UAV 100.

The defining unit 315 can determine whether the required speed exceeds the limit speed (S108). When the required speed does not exceed the limit speed, the defining unit 315 can determine that there is no need to modify the imaging condition and imaging direction of the imaging device 300, and the UAV 100 can move to the target position in time for the next frame without modification to the imaging condition or imaging direction of the imaging device 300 (S110).

Conversely, when the required speed is greater than the limit speed, the position determining unit 314 can determine the attained position that the UAV 100 is able to reach at the time point of the next frame by moving toward the target position at the limit speed (S112). When the object is imaged from the attained position, the defining unit 315 can define the imaging condition and the imaging direction of the imaging device 300 (S114). The defining unit 315 can define the imaging direction of the imaging device 300 based on the relative positions of the UAV 100 (at the attained position) and the object. The defining unit 315 can define the focus condition of the imaging device 300 for the next frame based on the distance between the UAV 100 (at the attained position) and the object at the time point of the next frame. The defining unit 315 can define the zoom condition of the imaging device 300 for the next frame based on the difference between the predetermined distance and the distance between the UAV 100 (at the attained position) and the object at the time point of the next frame.

The imaging control unit 310 can issue an instruction to the lens control unit 320 and the UAV control unit 110 to modify the imaging direction and the imaging condition in time for the next frame (S116). The imaging control unit 310 can issue an instruction to the lens control unit 320 and can cause at least one, or all, of the plurality of lenses 326 to move along the optical axis to satisfy the imaging condition. The imaging control unit 310 can issue an instruction to the UAV control unit 110, and can use the gimbal 200 to adjust the attitude of the imaging device 300 to match the imaging direction. Then, the UAV 100 can move to the target position in time for the next frame while modifying the imaging condition and the imaging direction of the imaging device 300 (S110).

The imaging control unit 310 can determine whether a time has been reached for the tracking to end (S118). For example, the imaging control unit 310 can make the determination based on whether the imaging control unit 310 has received an instruction from the user to end the tracking. The imaging control unit 310 can also make the determination based on whether a predetermined end time has been reached. When the time for the tracking to end has not been reached, the UAV 100 repeats the process from step S100.

As noted above, with the present embodiment, when the object moves at a speed greater than the limit speed at which the UAV 100 is able to move while tracking, the future relative positions of the UAV 100 and the object can be predicted, and a future imaging condition and imaging direction of the imaging device 300 can be defined based on the future relative positions. The UAV 100 can control the imaging device 300 and the gimbal 200 based on the imaging condition and the imaging direction until reaching the attained position, and can adjust at least one of the zoom position, the focus position, or the imaging direction. This can prevent the imaging device 300 from being unable to adequately image the object during a period of time where the UAV 100 is unable to maintain the predetermined distance from the object.

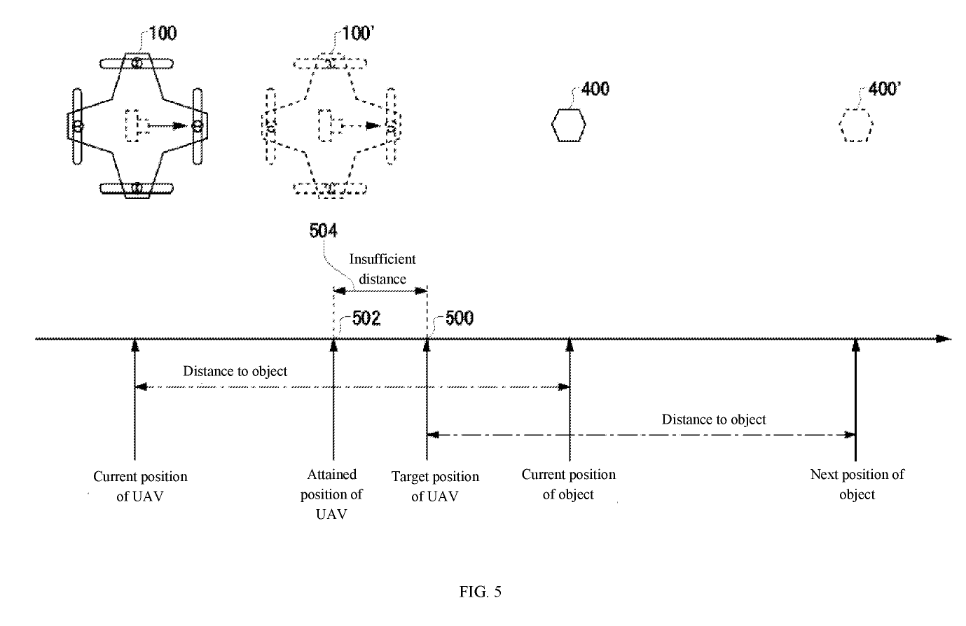

FIG. 5 illustrates one example of the UAV 100 tracking in a case where the UAV 100 moves along the imaging direction of the imaging device 300. The UAV 100 can be configured to track an object 400. At the time point of the next frame, the object 400 can shift to an object 400′. When the UAV 100 attempts to maintain the predetermined distance from the object 400′, the UAV 100 must move to a target position 500. However, the UAV 100 can actually only move as far as an attained position 502 by the time point of the next frame. Therefore, the UAV 100 covers an insufficient distance to reach the target position 500, instead reaching only a distance 504. To compensate for the insufficient distance 504, the UAV 100 can adjust at least one of the zoom position or the focus position of the imaging device 300. This can prevent the imaging device 300 from being unable to adequately image the object 400′ in the next frame as a consequence of the insufficient movement distance.

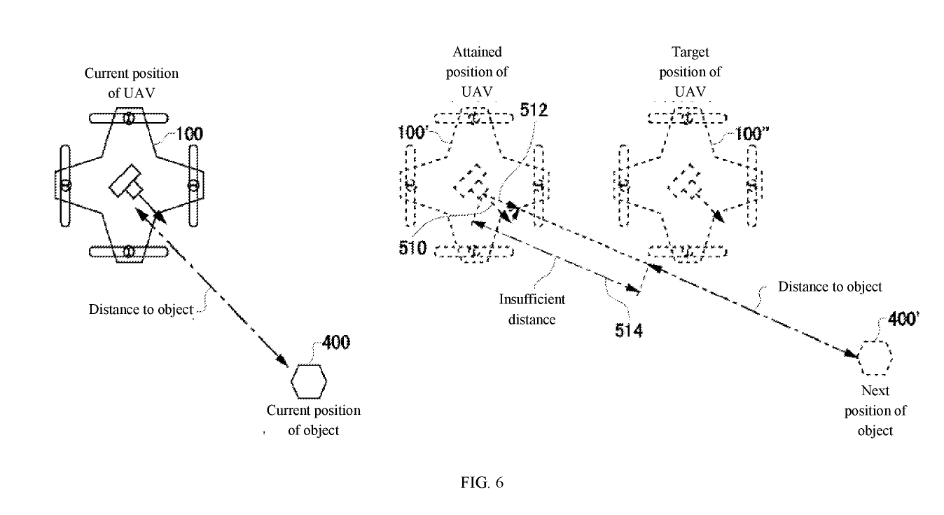

FIG. 6 illustrates another example of the UAV 100 tracking in a case where the UAV 100 moves in a direction other than the imaging direction of the imaging device 300. In the example illustrated in FIG. 6, the UAV 100 moves parallel to the movement direction of the object 400. Before the time point of the next frame, the object 400 can shift to the object 400′. In order to maintain the predetermined distance from the object 400′, the UAV 100 must move to a position of a UAV 100″. However, the UAV 100 can actually only move to a position of a UAV 100′. In such a case, the UAV 100 can modify the imaging direction of the imaging device 300 at the attained position, which the UAV 100 reaches by the time point of the next frame, from an imaging direction 510 to an imaging direction 512. Moreover, to compensate for the insufficient distance to the object 400′ in the next frame, at least one of the zoom position or the focus position of the imaging device 300 can be adjusted. This can prevent the imaging device 300 from being unable to adequately image the target 400′ in the next frame as a consequence of the insufficient movement distance, even when the UAV 100 moves in a direction other than the imaging direction of the imaging device 300.

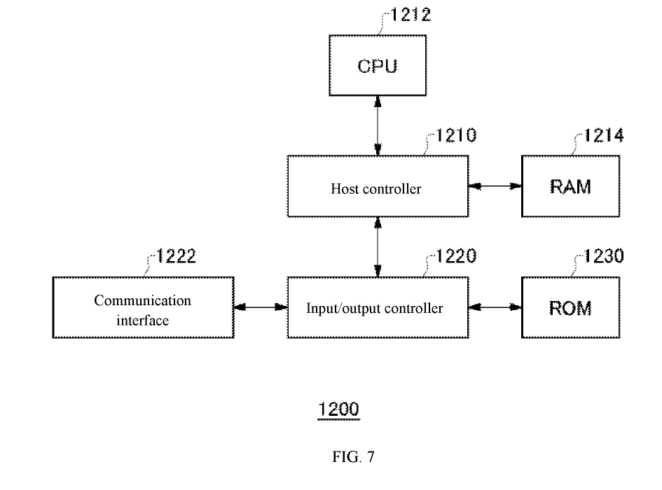

FIG. 7 illustrates one example of a computer 1200 that can entirely or partially realize a plurality of aspects of the present disclosure. A program installed on the computer 1200 can cause the computer 1200 to function as operations related to devices according to an embodiment of the present disclosure, or as one or a plurality of “units” of the devices. Alternatively, the program can cause the computer 1200 to execute the operations or the one or plurality of “units.” The program can cause the computer 1200 to execute a process or the steps of a process according to an embodiment of the present disclosure. Such a program can cause the computer 1200 to execute specific operations related to some or all of the blocks of the flowcharts and block diagrams described in the present specification by executing the program via a CPU 1212.

The computer 1200 according to the present embodiment can include the CPU 1212 and a RAM 1214, and these can be mutually connected by a host controller 1210. The computer 1200 can further include a communication interface 1222 and an input/output unit, and these can be connected to the host controller 1210 via an input/output controller 1220. The computer 1200 can further include a ROM 1230. The CPU 1212 can act in accordance with a program stored in the ROM 1230 and the RAM 1214, and can control each unit thereby.

The communication interface 1222 can communicate with other electronic devices via the network. A hard disc drive can store the programs and data to be used by the CPU 1212 of the computer 1200. The ROM 1230 can store therein boot programs and the like that are executed by the computer 1200 during activation and/or programs that depend on hardware of the computer 1200. The programs can be provided via a computer-readable recording medium like a CD-ROM, USB memory, or an IC card, or via a network. The programs can be installed on the RAM 1214 or the ROM 1230, which are examples of a computer-readable recording medium, and can be executed by the CPU 1212. The information processes written in these programs can be read by the computer 1200, and can bring about the coordination between the programs and the various types of hardware resources described above. Devices or methods can be configured by the manipulation or processing of information achieved through use of the computer 1200.

For example, when communication is carried out between the computer 1200 and an external device, the CPU 1212 can execute a communication program loaded in the RAM 1214, and can instruct the communication interface 1222 to perform communication processes based on the processes written in the communication program. Under the control of the CPU 1212, the communication interface 1222 can read sending data stored in a sending buffer processing region provided on a recording medium such as the RAM 1214 or USB memory, and can send the read sending data to the network, or can write receiving data received from the network to a receiving buffer processing region or the like provided on the recording medium.

Further, the CPU 1212 can make the entirety or needed portions of files or a database stored on an external recording medium such as USB memory be read by the RAM 1214, and can execute a variety of types of processes on the data that is on the RAM 1214. The CPU 1212 then writes back the processed data to the external recording medium.

A variety of types of programs and a variety of types of information like data, tables, and databases can be stored on the recording medium and can accept information processing. The CPU 1212 can execute, on data read from the RAM 1214, a variety of types of processes designated by an instruction sequence of the program and described throughout the present disclosure, and can write back the results to the RAM 1214. The variety of types of processes can include a variety of types of operations, information processing, condition determination, conditional branching, unconditional branching, information search/replace, and the like. Further, the CPU 1212 can search the information in the files, databases, and the like on the recording medium. For example, a plurality of entries can be stored on the recording medium. Each of the plurality of entries can have an attribute value of a first attribute that is related to an attribute value of a second attribute. When the plurality of entries are stored on the recording medium, the CPU 1212 can search among the plurality of entries for an entry that matches the search conditions and has a designated attribute value for the first attribute. The CPU 1212 can then read the attribute value of the second attribute stored in the entry, and can thereby acquire the attribute value of the second attribute that is related to the first attribute that fulfills preset conditions.

The program or software module described above can be stored on the computer 1200 or on a computer-readable medium near the computer 1200. Further, a recording medium like a hard disc or RAM provided in a server system connected to a private communications network or the Internet can be used as the computer-readable medium, and the program can thereby be provided to the computer 1200 via the network.

The present disclosure is described using embodiments, but the technical scope of the disclosure is not limited to the scope of the above embodiments. It should be clear to a person skilled in the art that the above embodiments are open to various modifications or improvements. It should also be clear from the scope of the claims that forms having such modifications or improvements can be included in the technical scope of the present disclosure.

The order of each process in the operations, procedures, steps, stages, and the like of the devices, systems, programs, and methods in the scope of the claims, specification, and drawings is not specifically disclosed using “beforehand,” “in advance,” and the like, and any order is possible as long as a postprocess does not use the output of a preprocess. Even if “first,” “next,” and the like are used for convenience in describing the flow of operations in the scope of the claims, specification, and drawings, it is not meant that it must be executed in this order.

### DESCRIPTION OF REFERENCE NUMERALS

100 UAV

102 UAV body

110 UAV control unit

112 Distance meter

150 Communication interface

160 Memory

200 Gimbal

210 Rotary wing mechanism

230 Imaging device

240 GPS receiver

260 Magnetic compass

270 Barometric altimeter

300 Imaging device

310 Imaging control unit

311 Object extracting unit

312 Estimating unit

313 Derivation unit

314 Position determining unit

315 Defining unit

316 Speed determining unit

317 Predicting unit

318 Lens position management unit

320 Lens control unit

322 Lens movement mechanism

324 Lens position detection unit

326 Lens

330 Imaging element

340 Memory

1200 Computer

1210 Host controller

1212 CPU

1214 RAM

1220 Input/output controller

1222 Communication interface

1230 ROM

What is claimed is:

1. A control device comprising:
a control circuitry configured to:
estimate a first position that a movable object needs to reach by a time point in association with movement of an object;
derive a first speed that the movable object needs to reach the first position by the time point;
determine if the first speed is greater than a second speed, beyond which the movable object is not able to track the object;
determine, in response to the first speed being greater than the second speed, a second position that the movable object is able to reach by the time point by moving toward the first position at the second speed; and
define at least one of an imaging condition or an imaging direction of an imaging system carried by the movable object based on a relative position between the movable object at the second position and the object at the time point, the imaging condition and the imaging direction being used for imaging the object with the imaging system at the time point.

2. The control device of claim 1, wherein the control circuitry is further configured to define at least one of a focus condition or a zoom condition of the imaging system as the imaging condition, based on a distance between the movable object at the second position and the object at the time point.

3. The control device of claim 2, wherein the control circuitry is further configured to:
define the focus condition of the imaging system based on the distance between the movable object at the second position and the object at the time point; and
define the zoom condition of the imaging system based on a difference between a predetermined distance and the distance between the movable object at the second position and the object at the time point.

4. The control device of claim 1, wherein the control circuitry is further configured to determine the second speed.

5. The control device of claim 4, wherein the control circuitry is further configured to:
predict a movement direction of the movable object while the movable object is moving toward the first position; and
determine the second speed based on the movement direction of the movable object.

6. The control device of claim 4, wherein the control circuitry is further configured to:
predict environmental conditions in an environment of the movable object while the movable object is moving toward the first position; and
determine the second speed based on the environmental conditions.

7. The control device of claim 1, wherein:
the imaging system includes a plurality of imaging devices; and
the control circuitry is further configured to control the plurality of imaging devices.

8. The control device of claim 7, wherein the control circuitry is further configured to measure a distance from the object based on images captured by the plurality of imaging devices.

9. The control device of claim 1, wherein the control circuitry is further configured to control the movable object to avoid obstacles based on environment around the movable object.

10. The control device of claim 1, wherein the control circuitry is further configured to extract the object from an image obtained from an imaging element of the imaging system.

11. The control device of claim 10, wherein the control circuitry is further configured to infer color, brightness, or contrast of the image including the object.

12. The control device of claim 10, wherein the control circuitry is further configured to set the object as a subject that is closest to the movable object.

13. The control device of claim 10, wherein the control circuitry is further configured to continue extracting the object until a new object is selected.

14. The control device of claim 10, wherein the first speed is derived based on a frame including the image.

15. The control device of claim 1, wherein the control circuitry is further configured to determine the second speed.

16. An imaging system comprising:
an imaging device carried by a movable object; and
a control circuitry configured to:
estimate a first position that the movable object needs to reach by a time point in association with movement of an object;
derive a first speed that the movable object needs to reach the first position by the time point;
determine if the first speed is greater than a second speed, beyond which the movable object is not able to track the object;
determine, in response to the first speed being greater than the second speed, a second position that the movable object is able to reach by the time point by moving toward the first position; and
define at least one of an imaging condition or an imaging direction of the imaging device based on a relative position between the movable object at the second position and the object at the time point;
wherein the imaging device is configured to image the object at the time point based on the imaging condition.

17. The imaging system of claim 16, wherein the control circuitry is further configured to define a rotation amount of the imaging device.

18. The imaging system of claim 17, wherein the rotation amount of the imaging device is adjusted by a gimbal.

19. The imaging system of claim 16, further comprising:
a carrier supporting the imaging device such that the imaging direction of the imaging device is adjustable.

20. A movable object comprising the imaging system of claim 16.
